(19) United States
(12) Patent Application Publication
(10) Pub. No.: US 2012/0084452 A1
(43) Pub. Date: Apr. 5, 2012

(54) REMOTE CONTROL COMMAND TRANSLATION

(75) Inventors: Bradley Robert Pettit, Los Gatos, CA (US); Andrew Scott, Los Gatos, CA (US)

(73) Assignee: MICROSOFT CORPORATION, Redmond, WA (US)

(21) Appl. No.: 12/896,711

(22) Filed: Oct. 1, 2010

(51) Int. Cl. G06F 15/16

(52) U.S. Cl. 709/230

(57) ABSTRACT

Embodiments are disclosed that relate to translating remote control commands. One embodiment provides a remote control command translation device comprising a network receiver configured to receive one or more metacommands via a first protocol and a transmitter configured to output one or more translated commands via a unidirectional protocol, wherein the unidirectional protocol is different than the first protocol. The remote control command translation device further comprises a logic subsystem configured to execute instructions and a data-holding subsystem comprising mass storage containing translation information and instructions executable by the logic subsystem to receive, via the network receiver, a metacommand from a remote device via the first protocol, to translate the metacommand into a translated command based on the translation information, and to transmit, via the transmitter, the translated command corresponding to the metacommand via the unidirectional protocol.

### BACKGROUND

Remote controls may be used to interface with various types of electronic devices, and in many cases, to control such electronic devices wirelessly. Remote controls may utilize different technologies for transmitting commands wirelessly, including but not limited to infrared protocols and radio frequency protocols. In light of the various protocols utilized by different devices, a user either may use a different remote for each device, or use a universal remote to control two or more devices. However, programming a universal remote may be tedious and time-consuming, and may contribute to a frustrating user experience. Further, a universal remote may support a limited number of electronic devices, and/or may have difficulty supporting legacy devices.

### SUMMARY

Various embodiments are disclosed herein that relate to translating remote control commands. For example, one disclosed embodiment provides a remote control command translation device comprising a network receiver configured to receive one or more metacommands via a first protocol, and a transmitter configured to output one or more translated commands via a unidirectional protocol, wherein the unidirectional protocol is different than the first protocol. The remote control command translation device further comprises a logic subsystem configured to execute instructions and a data-holding subsystem comprising mass storage containing translation information. The remote control command translation device further comprises instructions executable by the logic subsystem to receive, via the network receiver, a metacommand from a remote device via the first protocol, to translate the metacommand into a translated command based on the translation information, and to transmit, via the transmitter, the translated command corresponding to the metacommand via the unidirectional protocol.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram depicting an embodiment of a remote control command translation device in an example use environment.

FIG. 2 shows a block diagram of an embodiment of a method for translating remote control commands accordance with an embodiment of the present disclosure.

FIG. 3 schematically shows example use scenarios for an embodiment of a remote control command translation device.

### DETAILED DESCRIPTION

As mentioned above, users may interface with various electronic devices, such as televisions, media-disc players, home entertainment system components, etc. via hand-held wireless remote controls. Traditionally, many such remote controls have been configured to communicate with corresponding endpoint devices via unidirectional wireless protocols, such as infrared and radio frequency protocols.

Due to the use of different remote control communications protocols by different electronic devices, a user of multiple electronic devices in a media consumption environment may either have to use multiple remote controls, or consolidate remotes associated with various devices by using a universal remote. However, the programming of such universal remotes may be tedious, and may result in one or more devices still being incompatible with the universal remote.

Thus, it may be desirable to utilize as a remote control device a mobile device, such as a mobile phone, which a user may have readily available for other uses. However, while mobile phones and other such commonly used mobile devices (e.g., portable media players, notepad computers, laptop computers, etc.) commonly support wireless protocols such as 802.11x, Bluetooth, etc., they may not support protocols used by televisions and other legacy devices, such as various radio frequency and infrared protocols.

Therefore, embodiments are disclosed herein that relate to the translation of metacommands sent by a remote device via a first protocol into commands for transmission to an endpoint device via a second protocol, where such translation is performed by an intermediate device.

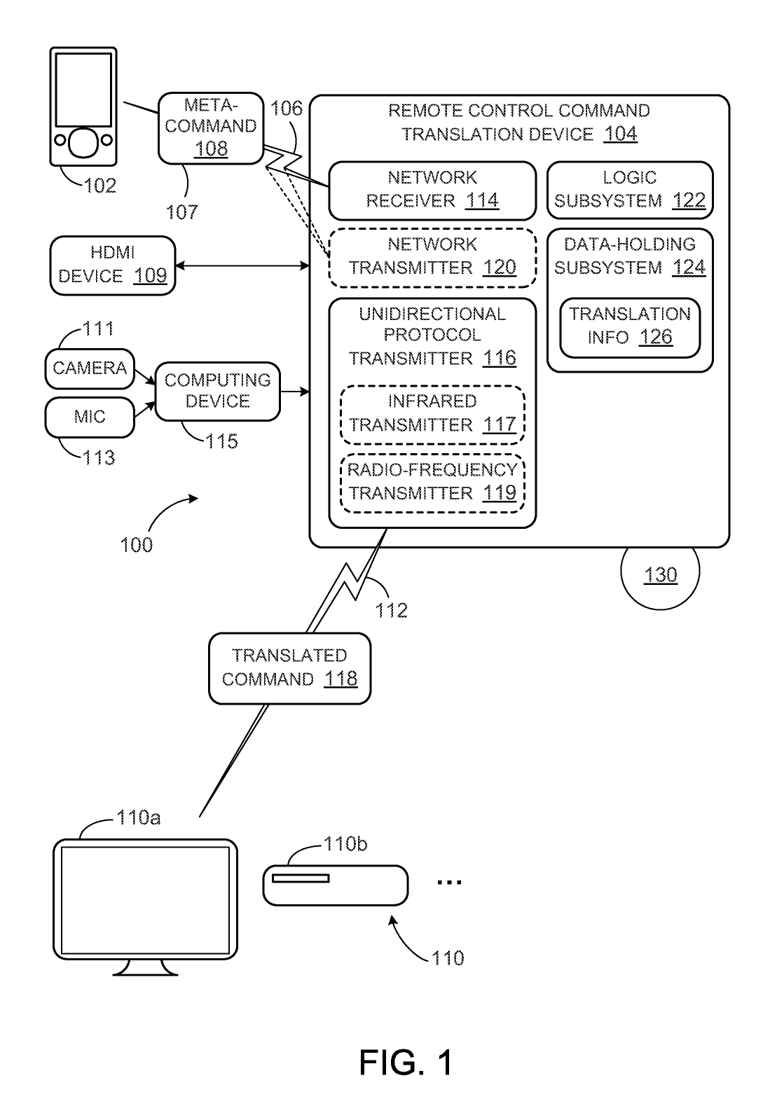

FIG. 1 illustrates an example use environment 100 comprising a remote device 102 configured to communicate with a remote control command translation device 104 via a first protocol 106. First protocol 106 may be any suitable unidirectional or bidirectional protocol, and further, may be a wired protocol or a wireless protocol. Nonlimiting examples of first protocol 106 include 802.11x, Bluetooth, UDP/IP (user datagram protocol over an IP network), and TCP/IP (transmission control protocol over an IP network). With regard to remote device 102, as nonlimiting examples, remote device 102 may be a mobile phone, a portable media player, a notepad computer, a laptop computer, a dedicated remote control device, a notebook computer, or another suitable computing device.

In some embodiments, a high-definition multimedia interface (HDMI)-enabled media device 109 may be configured to communicate with remote control command translation device 104. HDMI enables media device 109 to control other media devices via consumer electronic control (CEC) commands sent to the other media devices via a CEC bus of a HDMI cable. However, an HDMI media device may not directly control a legacy device, such as a non-HDMI television. Thus, the HDMI media device may send a desired command to remote control command translation device 104, which may then translate the command for the legacy device and send the command to the legacy device via a supported protocol. In this way, legacy devices may be more readily supported in an HDMI environment.

Remote device 102 is configured to send a request 107 comprising a metacommand 108 to remote control command translation device 104. Metacommand 108 comprises information useable by remote control command translation device 104 to determine a corresponding command to be sent to one or more endpoint devices 110 via one or more protocols other than first protocol 106, such as one or more unidirectional protocols 112 specified in the request 107. Nonlimiting examples of endpoint devices include a television 110a or other display device, and a media device 110b that is configured to provide content to a display device. Examples of such media devices 110b include, but are not limited to, a DVD player, Blu-ray player, HD-DVD players, digital video recorders (DVR), set-top-boxes, networked computing devices, and any other suitable device for delivering content to a display device.

It should be appreciated that unidirectional protocol 112 is different than first protocol 106. As mentioned above, examples of unidirectional protocol 112 include, but are not limited to, wireless protocols such as infrared protocols and radio frequency protocols.

Remote control command translation device 104 is configured to receive such metacommands from remote device 102, and to translate such metacommands into commands recognizable by endpoint devices 110. Remote control command translation device 104 is further configured to transmit the commands to endpoint devices 110 after translation. In this way, remote device 102 may communicate with one or more otherwise incompatible endpoint devices 110 via remote control command translation device 104. This may allow non-networked endpoint devices to be supported in a networked entertainment consumption environment. Further, in some embodiments, remote control command translation device 104 may be configured to receive inputs from other sources, such as visual inputs (e.g., gesture inputs) via a camera 111 and/or audio inputs (e.g., voice commands) via a microphone 113. In such cases, such inputs may be intermediately processed into metacommands, for example, by a computing device 115 which then provides the metacommands to remote control command translation device 104. Further, such inputs may be received by computing device 115 via a digital protocol, and computing device 115 may be further configured to perform a digital-to-analog conversation of the input data.

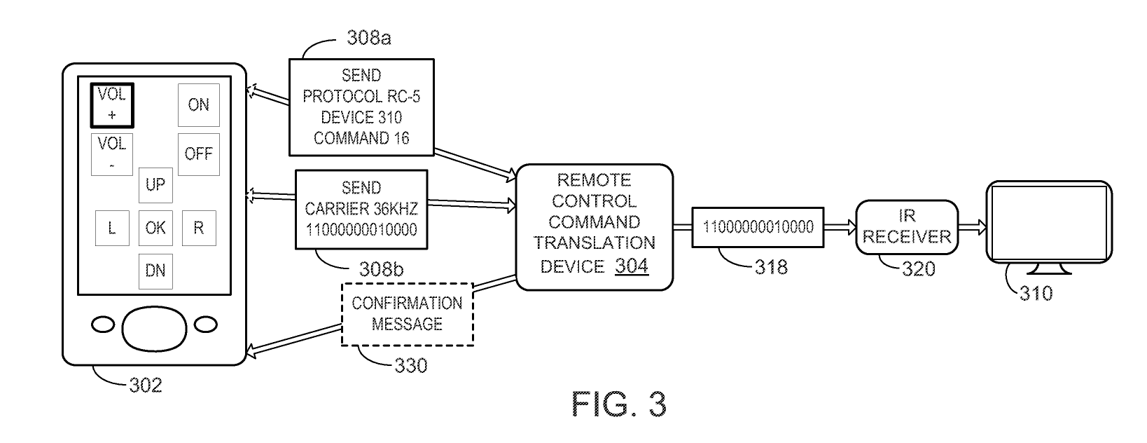

In addition to metacommand 108, request 107 may comprise any suitable information. For example, request 107 may specify a unidirectional protocol 112 to be used to transmit the command to an intended endpoint device, and/or may specify an identity of an intended endpoint device, as described in more detail below with reference to FIG. 3.

As a more specific example, request 107 may specify that a “power on” command is to be transmitted via an infrared protocol known by remote device 102 to be utilized by television 110a. Upon receipt of the request 107, the remote control command translation device 104 translates the metacommand 108 into the requested command, and then transmits the translated command 118 via the requested protocol. It should be further appreciated that the request 107 may specify more than one command to be sent via more than one specified protocol. It will be understood that these examples are intended to be illustrative and not limiting in any manner.

Remote control command translation device 104 may include any suitable components to perform the various functions described herein. For example, remote control command translation device 104 may include a wireless or wired network receiver 114 for receiving metacommands via first protocol 106. The remote control command translation device 104 may further include one or more unidirectional protocol transmitters 116 for outputting translated commands via one or more protocols, such as unidirectional protocol 112. Examples of such transmitters 116 include, but are not limited to, infrared transmitters 117 and radio frequency transmitters 119.

Depending upon the protocol used by an endpoint device, remote control command translation device 104 may or may not be positioned within a line-of-sight of an endpoint device. For example, the remote control command translation device 104 may be positioned in the line-of-sight of an endpoint device that utilizes an infrared protocol, but may be positioned otherwise, if desired, relative to an endpoint device that uses a radio frequency protocol. Further, in some embodiments, remote control command translation device 104 may include a scanning mechanism configured to scan an infrared beam or other directional signal across a use environment to decrease any chance of a transmitted command not reaching an intended endpoint device.

Continuing with FIG. 1, in some embodiments, remote control command translation device 104 may further include a second transmitter, such as the depicted network transmitter 120, to enable the transmission of messages to remote device 102 via the first protocol 106. This may enable remote control command translation device 104 to transmit acknowledgements, status messages and other such communications back to remote device 102.

Remote control command translation device 104 may further include a logic subsystem 122 configured to execute instructions, and a data-holding subsystem 124. The data-holding subsystem 124 comprises computer-readable storage media, such as mass storage, containing translation information 126 used to translate metacommands into corresponding commands, and also containing instructions executable by the logic subsystem 122 to perform various tasks related to the translation of remote control commands. Translation information 126 may be updated on occasion by receiving updated translation information from a network server via remote device 102, via network receiver 114, or in any other suitable manner. It will be understood that the methods and processes described herein may be implemented as one or more computer applications, computer services, computer APIs, computer libraries, and/or other computer program products.

In some embodiments, remote control command translation device 104 may also optionally include one or more user input devices (e.g., keypad, touch surface, keyboard, etc.) and/or a display subsystem. It is to be understood that remote control command translation device 104 may take any suitable physical form, and may be configured to have an ornamental and/or stylized appearance to complement the décor of an entertainment consumption environment.

Logic subsystem 122 may include one or more physical devices configured to execute one or more instructions. For example, logic subsystem 122 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 122 may include one or more processors that are configured to execute software instructions. Additionally or alternatively, logic subsystem 122 may include one or more hardware or firmware logic machines configured to execute hardware or firmware instructions. Processors of logic subsystem 122 may be single core or multicore, and the programs executed thereon may be configured for parallel or distributed processing. Logic subsystem 122 may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 124 may include one or more physical, non-transitory, devices and/or computer-readable media configured to hold data and/or instructions executable by the logic subsystem to implement the herein described methods and processes, and also to hold other information such as translation information 126. When such methods and processes are implemented, the state of data-holding subsystem 124 may be transformed (e.g., to hold different data).

Data-holding subsystem 124 may include removable media and/or built-in devices and media. Data-holding subsystem 124 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 124 may include devices with one or more of the following characteristics: volatile, nonvolatile, dynamic, static, read/write, read-only, random access, sequential access, location addressable, file addressable, and content addressable. In some embodiments, logic subsystem 122 and data-holding subsystem 124 may be integrated into one or more common devices, such as an application specific integrated circuit or a system on a chip.

FIG. 1 also shows an aspect of the data-holding subsystem in the form of removable computer-readable storage media 130, which may be used to store and/or transfer data and/or instructions executable to implement the herein described methods and processes. Removable computer-readable storage media 130 may take the form of CDs, DVDs, HD-DVDs, Blu-Ray Discs, EEPROMs, and/or floppy disks, among others.

The remote device 102 also may include a data-holding subsystem comprising computer-readable media, a logic subsystem, a communication subsystem, a display subsystem, and any other suitable components (not shown in FIG. 1). It will be understood that the data-holding subsystem of the remote device 102 may include instructions stored thereon that are executable by the logic subsystem of the remote device 102 for performing one or more of the herein-described embodiments, including but not limited to sending a metacommand-containing request to remote control command translation device 104.

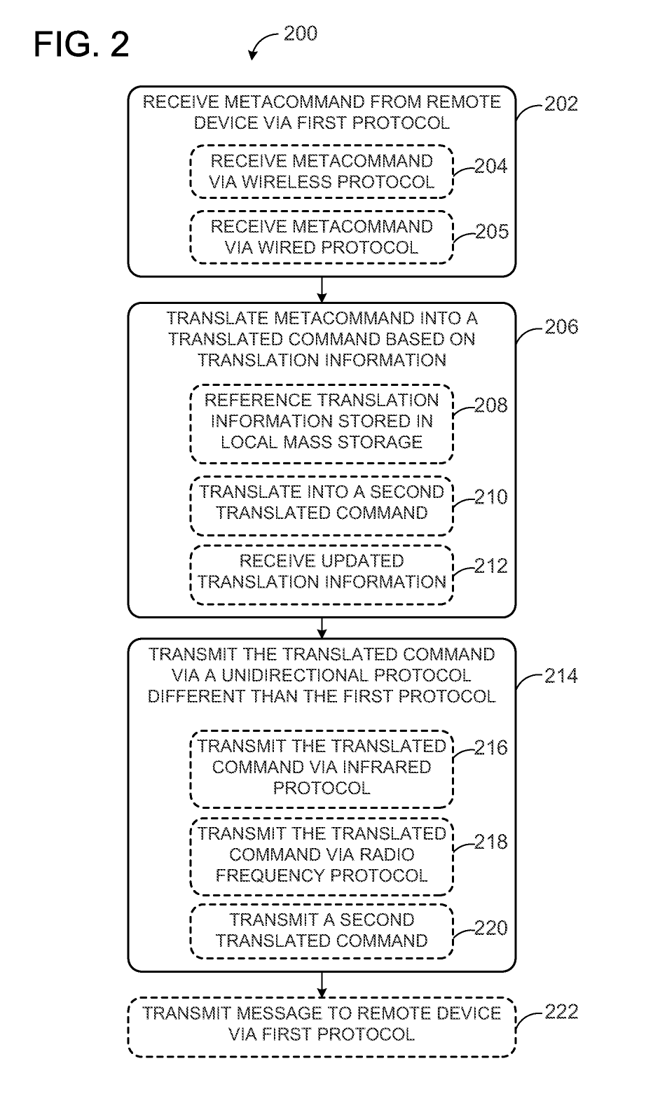

FIG. 2 illustrates an example method 200 of translating a remote control command for an endpoint device. At 202, method 200 includes receiving, via a network receiver a metacommand from a remote device (such as a mobile device or HDMI-enabled device) via a first protocol. This may include, for example, receiving a metacommand via a wireless network protocol, as indicated at 204, or via a wired protocol such as HDMI, TCP/IP, etc. as indicated at 205. The metacommand and/or a message comprising the metacommand may indicate a command to be transmitted to an endpoint device via a unidirectional protocol (e.g., unidirectional protocol 112) which is different than the first protocol, and also may include device information and/or protocol information indicating the desired endpoint device and/or unidirectional protocol to be used to transmit the command to the desired endpoint device.

At 206, method 200 includes translating the metacommand into a translated command (e.g., translated command 118) based on translation information. In some embodiments, the remote control command translation device may include locally-stored translation information. In such a case, translating the metacommand may include referencing the translation information and obtaining the command corresponding to the metacommand, as indicated at 208. It should be appreciated that such translation information may include information to assist translations from any suitable set of wireless or wired protocols to any suitable set of unidirectional protocols (e.g., infrared protocols, radio frequency protocols, etc.). In other embodiments, the translation information may be stored remotely and accessed via a network to which the remote control command translation device is connected.

The metacommand received at 202 may further comprise additional commands to be transmitted to the endpoint device, and/or instructions to translate a metacommand and transmit a corresponding command for plural endpoint devices via two or more different protocols. In such a case, method 200 may further include translating the metacommand into a second command, as indicated at 210, wherein the second command may be another command to the same endpoint device, a same command to a different endpoint device, a different command to a different endpoint device, etc.

As mentioned above, the remote control command translation device may be configured to receive updated translation information so that the remote control command translation device may be updated to communicate via with new endpoint devices, via new protocols, and/or to be adapted to other such changes. In such a case, method 200 may further include receiving updated translation information and storing the updated translation information in the local mass storage, as indicated at 212. The updated translation information may be received via remote device 102, and/or over another network connection (e.g., via network receiver 114).

At 214, method 200 includes transmitting the translated command corresponding to the metacommand via the unidirectional protocol. As an example, this may include transmitting the translated command via an infrared protocol and/or a radio frequency protocol as indicated at 216 and 218. Such transmitting may be based on protocol and/or device information included in the request with the metacommand. For example, the request including the metacommand may specify, in addition to the desired command, a desired protocol and/or a desired endpoint device to which the command is to be transmitted.

In the case that the request indicates a second command to be transmitted, then method 200 further includes transmitting the second command in addition to transmitting the first command, as indicated at 220. The second command may be transmitted via the same unidirectional protocol as the first command, or via a different unidirectional protocol. Thus, as a nonlimiting example, method 200 may include transmitting an infrared command to a first endpoint device, and transmitting a radio frequency command to a second endpoint device.

In some embodiments, the remote control command translation device may communicate with the remote device, for example, to send various items of information to the remote device. Thus, method 200 may optionally include transmitting one or more messages to the remote device via the first protocol, as indicated at 222. As nonlimiting examples, this may include transmitting a status message and/or message confirming transmission of one or more translated commands.

FIG. 3 illustrates examples of possible use scenarios for a remote control command translation device according to the present disclosure. In a first example, a remote device 302 sends a request comprising a metacommand 308a to a remote control command translation device 304. The metacommand may indicate, for example, a “volume up” command to be transmitted via an infrared protocol to a television 310. As shown by way of example, request 308a may therefore include a metacommand (e.g., “command 16”), protocol information (e.g., “protocol RC-5”) indicating the protocol for transmitting the translated command, and device information (e.g., “device 310”) indicating an endpoint device.

As such, remote control command translation device 304 translates the metacommand to produce the translated command 318, and transmits translated command 318 to an infrared receiver 320 of television 310 via the RC-5 protocol in the form of a low level bit-pattern (e.g., “11000000010000”). As another example, the metacommand may instead indicate the actual bit pattern to be transmitted (e.g., “11000000010000”), and the protocol information may include a carrier frequency (e.g., “carrier 36 kHz”) over which to transmit the command, as illustrated at 308b. FIG. 3 also illustrates an example of remote control command translation device 304 sending a message 330 back to remote device 302, such as the depicted transmission confirmation message or other suitable message, via the first protocol. It should be appreciated that in some embodiments, the confirmation message may be received as a response on the same TCP connection which sent the original metacommand. It should be appreciated that sending such a confirmation message is optional, and may be dependent on the type of protocol by which the metacommand was received. For example, in the case of metacommands received via UDP, no such response and/or confirmation message is sent. Further, in some embodiments, metacommands may be received on a persistent connection, where the socket is kept open on both ends.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A remote control command translation device, comprising:
a network receiver configured to receive one or more metacommands via a first protocol;
a transmitter configured to output one or more translated commands via a unidirectional protocol, the unidirectional protocol being different than the first protocol;
a logic subsystem configured to execute instructions; and
a data-holding subsystem comprising mass storage containing translation information and instructions executable by the logic subsystem to:
receive, via the network receiver, a metacommand from a remote device via the first protocol;
translate the metacommand into a translated command based on the translation information; and
transmit, via the transmitter, the translated command corresponding to the metacommand via the unidirectional protocol.

2. The remote control command translation device of claim 1, wherein the first protocol comprises a wireless network protocol.

3. The remote control command translation device of claim 2, wherein the unidirectional protocol comprises an infrared protocol.

4. The remote control command translation device of claim 2, wherein the unidirectional protocol comprises a radio frequency protocol.

5. The remote control command translation device of claim 1, wherein the first protocol comprises a high-definition multimedia interface (HDMI) protocol.

6. The remote control command translation device of claim 1, wherein the instructions are further executable to translate the metacommand based on protocol information included in the metacommand and to transmit the translated command to an endpoint device based on device information included in the metacommand.

7. The remote control command translation device of claim 1, wherein the translation information further comprises information for translating the metacommand into a second translated command in addition to the translated command, and wherein the transmitter is further configured to output the second translated command via a second unidirectional protocol, the second unidirectional protocol being different than the unidirectional protocol.

8. The remote control command translation device of claim 1, further comprising a second transmitter configured to transmit one or more messages to the remote device via the first protocol.

9. On a remote control command translation device, a method of translating a remote control command, the method comprising:
receiving a metacommand from a mobile device via a first protocol, the metacommand indicating a first command to be transmitted to a first endpoint device via an infrared protocol, the infrared protocol being different than the first protocol;
translating the metacommand to the first command; and
transmitting the first command via the infrared protocol.

10. The method of claim 9, wherein translating the metacommand comprises obtaining the first command corresponding to the metacommand from translation information stored in local mass storage.

11. The method of claim 10, further comprising receiving updated translation information from one or more of the mobile device and a network server and storing the updated translation information in the local mass storage.

12. The method of claim 9, wherein the mobile device is a mobile phone.

13. The method of claim 9, wherein the first endpoint device is a display device.

14. The method of claim 9, wherein the first endpoint device is a media device.

15. The method of claim 9, wherein the metacommand is a first metacommand, and further comprising receiving a second metacommand from a high-definition multimedia interface (HDMI)-enabled device, translating the second metacommand to a second command, and transmitting the second command via the infrared protocol.

16. The method of claim 9, wherein the metacommand further indicates a second command to be transmitted to a second endpoint device via a radio frequency protocol, and wherein the method further comprises translating the metacommand to the second command in addition to translating to the first command, and transmitting the second command to the second endpoint device via the radio frequency protocol.

17. The method of claim 9, further comprising, upon transmitting the first command to the first endpoint device via the infrared protocol, transmitting a status message to the mobile device via the first protocol.

18. A mobile device comprising a logic subsystem and a data-holding subsystem comprising instructions stored thereon that are executable by the logic subsystem to:
send a request via a first protocol to a remote control command translation device, the request comprising:
a metacommand specifying a command to be transmitted; and
a protocol identification that identifies a unidirectional protocol to be used by the remote control command translation device to transmit the command to an endpoint device, the unidirectional protocol being different than the first protocol.

19. The mobile device of claim 18, wherein the unidirectional protocol comprises an infrared protocol.

20. The mobile device of claim 18, wherein the first protocol comprises a high-definition multimedia interface (HDMI) protocol.
